(19) United States
(12) Patent Application Publication
(10) Pub. No.: US 2022/0138818 A1
(43) Pub. Date: May 5, 2022

(54) TASK MANAGEMENT FOR ONLINE MARKETPLACE BRANDS

(71) Applicant: Darrin Levine, Minneapolis, MN (US)

(72) Inventor: Darrin Levine, Minneapolis, MN (US)

(21) Appl. No.: 17/089,719

(22) Filed: Nov. 4, 2020

(51) Int. Cl. G06Q 30/06; G06Q 10/06

(52) U.S. Cl. CPC G06Q 30/0609; G06Q 10/063112; G06Q 30/0641

(57) ABSTRACT

A task management system for brands on online marketplaces includes a graphic user interface (GUI) running on display devices and includes a server in communication with the display devices. The server is configured to: receive an input from at least one user to retrieve a bulk input of seller information, including task management information, from the online marketplace; retrieve and select the bulk input of seller information from the online marketplace; parse the bulk input for the task management information for creating a task; select at least one task management criterion for creating the task; and create the task based on the task management information and the task management criterion. The task is assignable to the user of the at least one user, displayed on the GUI after creation of the task, and is configured to promote the brand on the online marketplace and to streamline workflows of the brand.

### TECHNICAL FIELD

The present disclosure relates to task management systems and, in particular, to task management systems for online marketplaces.

### BACKGROUND

Brand management is an important part of building and maintaining a profitable brand. This much is true in both commercial and consumer sales. While business approaches for traditional, physical wholesale and retail marketplaces have widely incorporated backend management systems for managing their brands in store, the same cannot be said for brands operating on online marketplaces. Of course, brand management for online marketplaces has different challenges than for physical wholesale and retail marketplaces. Included among these challenges are the rapid pace with which brands are competing with each other to earn the business of consumers and, by extension, rapid, agile, and accurate brand management. These challenges and more should be considered when developing a solution for brand management for online marketplaces.

### SUMMARY

Disclosed herein are devices, systems, and methods for brand management. In particular, the present disclosure relates to managing tasks associated with brand management for online marketplaces. In this regard, the present disclosure allows team members to quickly review tasks, timelines, due-dates, progress updates tailored to meet the challenges of online marketplaces. In addition, disclosed devices, systems, and methods can intelligently, automatically, and quickly operate to, for instance, allow users to review daily, weekly, and monthly tasks based on selected criteria from the user and, when in an automation setting, automatically trigger an alert when a criterion has been met.

While multiple examples are disclosed, still other examples of the present invention will become apparent to those skilled in the art from the following detailed description, which shows and describes illustrative examples of the invention. Accordingly, the drawings and detailed description are to be regarded as illustrative in nature and not restrictive.

### BRIEF DESCRIPTION OF THE DRAWINGS

FIG. 1A is a schematic view of a task management system, according to principles of the present disclosure;

FIG. 1B is a view of an inventory dashboard of a graphic user interface of the task management system, according to principles of the present disclosure;

FIG. 1C is a view of a task management dashboard of a graphic user interface of the task management system, according to principles of the present disclosure;

FIG. 1D is a view of a support dashboard of a graphic user interface of the task management system, according to principles of the present disclosure;

FIG. 1E is a view of a support dashboard of a graphic user interface of the task management system, according to principles of the present disclosure;

FIG. 1F is a view of an alert from the task management system, according to principles of the present disclosure; and

FIG. 2 is a flowchart of a method of managing tasks for a brand on an online marketplace.

### DETAILED DESCRIPTION

For the purposes of promoting an understanding of the principles of the present disclosure, reference is now made to the examples illustrated in the drawings, which are described below. The exemplary examples disclosed herein are not intended to be exhaustive or to limit the disclosure to the precise form disclosed in the following detailed description. Rather, these exemplary examples were chosen and described so that others skilled in the art can utilize their teachings. It is not beyond the scope of this disclosure to have a number (e.g., all) the features in a given example to be used across all examples.

Online marketplaces such as AMAZON provide a platform to sell consumer goods online. In recent years, the online sale of goods has seen increased market penetration in consumer sales as consumers continue to elect to buy more goods online. For sellers, data regarding sales on the online marketplace are usually made available in the form of reports and bulk data. However, these reports and bulk data are typically generic in nature and therefore do not often readily provide specific insights to the seller to improve their brand's performance on the online marketplace. As well, these reports and bulk data do not include specific tasks for sellers to perform to improve their brand's performance on the online marketplace. As can be appreciated, these tasks can be plentiful and should be tailored to a specific online marketplace because not all marketplaces operate in a similar manner.

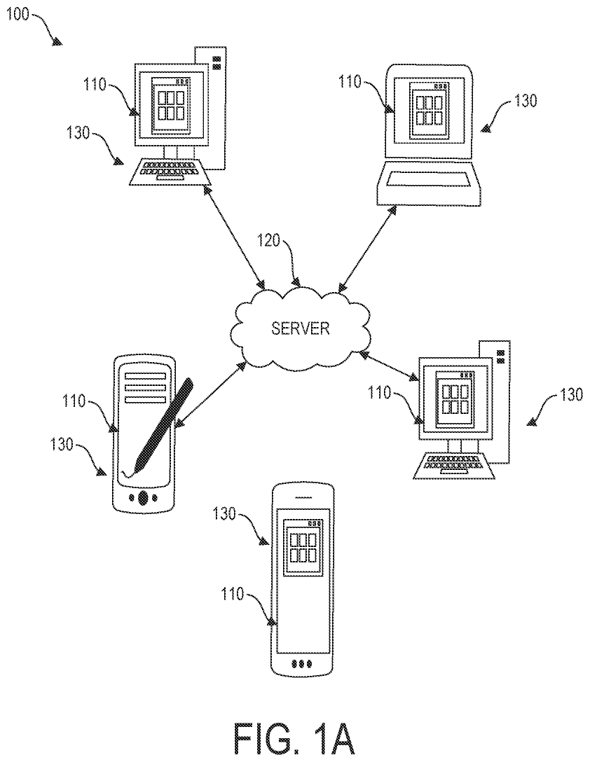

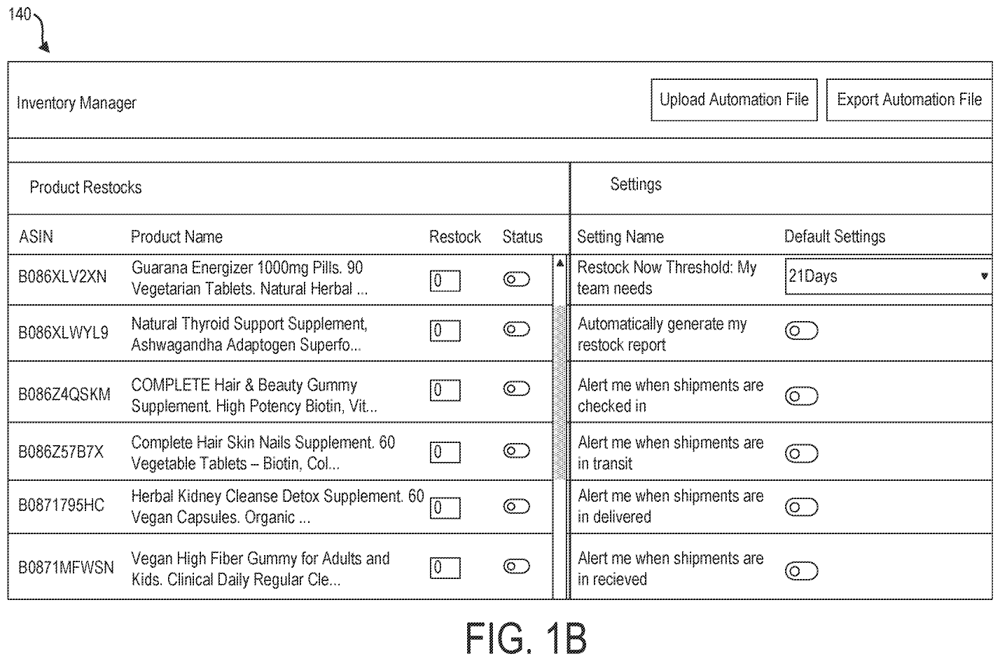

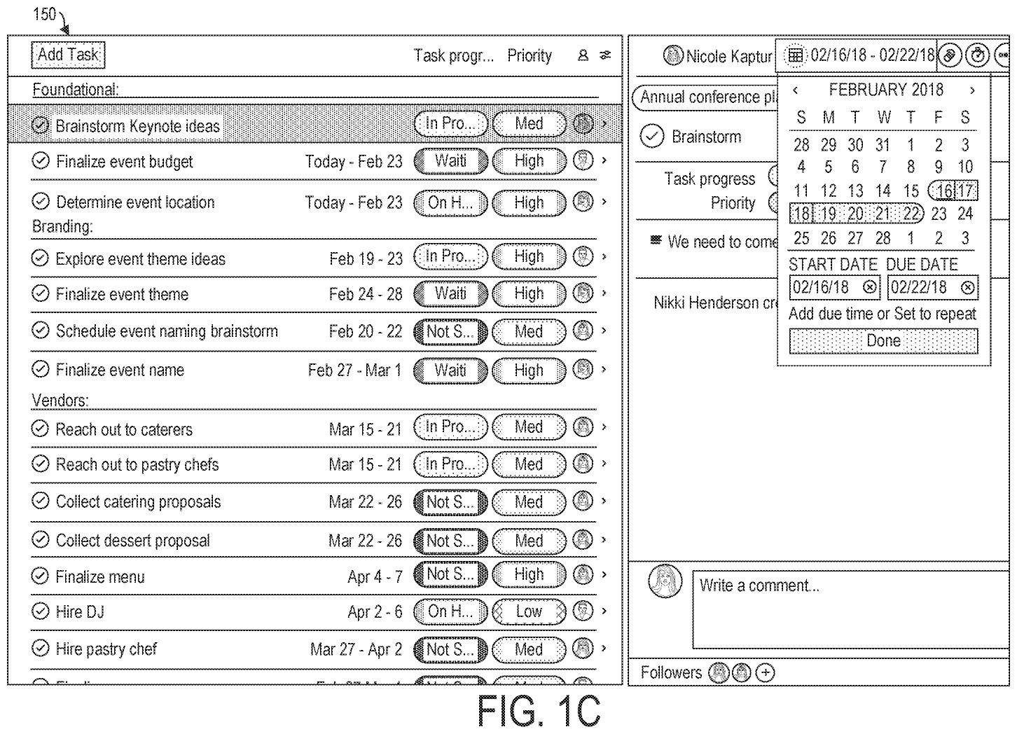

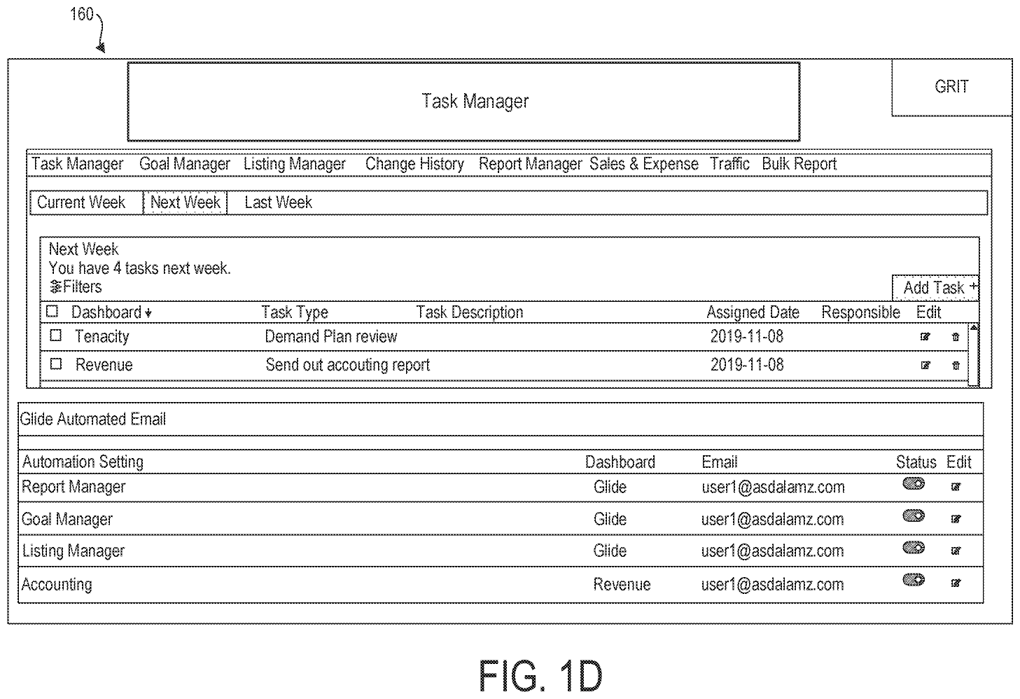

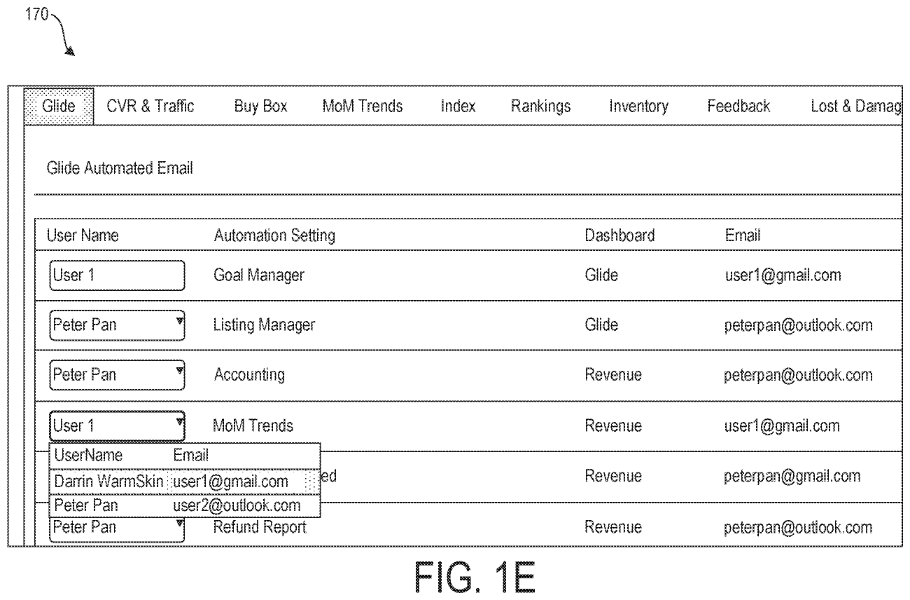

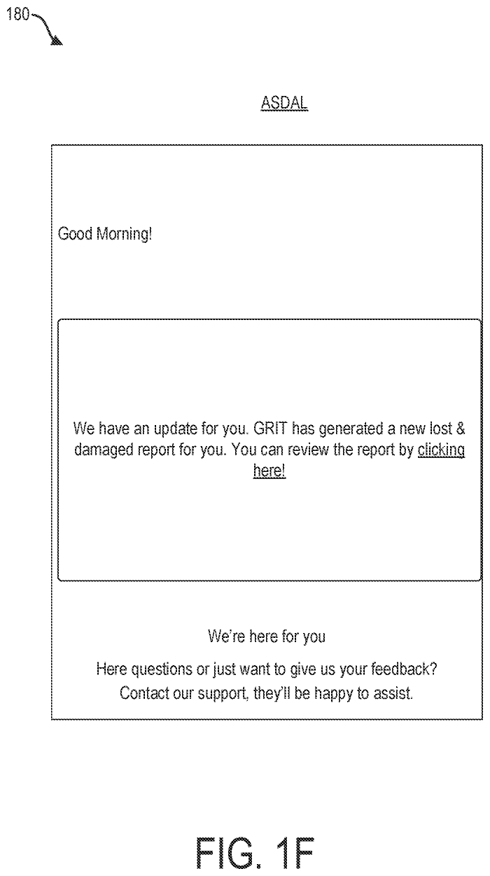

FIGS. 1A-1F show various views of a task management system 100, according to principles of the present disclosure. FIG. 1A is a schematic view of a task management system 100. FIG. 1B is a view of an inventory dashboard 140 of a graphic user interface 110 of the task management system 100. FIG. 1C is a view of a task management dashboard 150 of a graphic user interface 110 of the task management system 100. FIG. 1D is a view of a support dashboard of a graphic user interface 110 of the task management system 100. FIG. 1E is a view of a support dashboard of a graphic user interface 110 of the task management system 100. FIG. 1F is a view of an alert from the task management system 100, according to principles of the present disclosure.

Principles of the present disclosure are directed toward facilitating sellers brand management to improve their brand's performance in online marketplaces. Many examples employing principles of the present disclosure include task management devices, systems, and methods. Each of these examples can employ artificial intelligence principles such as machine learning and big data to provide sellers with actionable predictive intelligence solutions and insights that optimize sellers' brands in online marketplaces. The result can be in the form of a single- or multi-tenant software (e.g., software-as-a-service and/or mobile platform) that provides real-time, intelligent management and insights into a brand's performance.

According to principles of the present disclosure, a task management system 100 can be adapted for a brand on an online marketplace can include a graphic user interface 110 (GUI 110) and a server 120 such as a cloud server 120 and/or physical server 120 (best seen in FIG. 1A). The graphic user interface 110 can be running on a display device 130, such as a computer or a mobile device. The server 120 can be in communication (e.g., one-way or two-way communication) with the display device 130. As shown here, the server 120 is set up for multi-tenant software as a service where several display devices are in communication with the server 120. When different sellers are using each display device 130, their data can be aggregated to better inform intelligent operation (e.g., operation using artificial intelligence) of the system. In this and other instances, therefore, some or all of the display devices in communication with the server 120 can be configured to receive an input from at least one user to retrieve a bulk input of seller information from the online marketplace.

The server 120 can be configured to retrieve and select the bulk input of seller information from the online marketplace. The bulk data of seller information can include task management information that can be used to create tasks for the user. The server 120 can be configured to parse the bulk input for the task management information for creating a user task for a user of the at least one user. As used herein, task management information can any information that is useful in creating a task, for example, information corresponding to a profit and loss information, traffic, conversion rate, advertising performance, “buy box” performance, manufacturing operations management, indexing, rankings, feedback, inventory, lost products, damaged products, correspondence, and the like.

The server 120 can be configured to select at least one task management criterion for creating the user task. Each task management criterion can be applied globally with respect to all products or on a product-by-product or product-grouping basis. Using inventory as an example, a user can select (e.g., via an inventory dashboard 140 best seen in FIG. 1B) the lead time (e.g., days, weeks, months, etc.) for restocking, low inventory thresholds, overstock thresholds, and the like. As discussed further below, the thresholds can be used in conjunction with alerts. This example is just one example of many examples. Of course, similar thresholds (e.g., high value, low value, average value, and lead time) can be set up for advertising, profits, losses, traffic, rankings, quantity of feedback, and quantity of buyer messages for example. As well, triggers can be qualitatively set up using categorization of feedback (e.g., based on trigger words that indicate positive or negative feedback), buyer messages, or any other transcribed messages. In this regard, it should be understood that principles of this example can be used in one or more (e.g., all) examples of task management information for example.

Task management can be facilitated using the graphic user interface 110 to present the task management information and tasks in a useful and digestible form for the seller. In examples, the graphic user interface 110 can include a plurality of dashboards that includes a task management dashboard 150 in which each of the user tasks is displayed as discussed in detail below. The graphic user interface 110 can include at least one (e.g., one, two, three, etc.) departmental dashboard that categorizes the seller information by departmental functions of the brand, for example. Those departmental functions can include that include what are referred to as Glide, Revenue, Insights, and Tenacity (altogether, GRIT). Glide can include project management, listing management, tracking, and reporting functions. Revenue can include sales tracking, accounting, loss prevention, refund, monthly trends, and sales forecasting functions. Both Glide and Revenue can be directed toward informing operations (e.g., Operations Director) and support staff of the seller, for example. Insight can include keywords, visitor traffic, shopping cart analytics, seasonal trends, and listing search engine optimization (SEO). Insights can be directed toward informing marketing (e.g., Marketing Managers and Digital Marketing Specialists) and retail data & analytics support staff of the seller, for example. Tenacity can include advertising management, inventory management, customer service management, and operations management. Tenacity can be directed toward informing advertising managers, logistic coordinators, and customer service representatives of the seller, for example. The task management dashboard 150 can be configured to categorize the user tasks into groupings that correspond to each of the departmental dashboards in each dashboard of the at least one departmental dashboard.

The server 120 can be configured to create the user task based on the task management information and the at least one task management criterion. After creation, the user task can be assignable to a user. the user task can be displayed on the graphic user interface 110. For example, taking inventory, if inventory is low and needs to be restocked and a 21-day threshold for restocking inventory has occurred, a task can be created for inventory management and displayed on the Tenacity dashboard. In examples, the graphic user interface 110 can include various aspects of the user task, including one or more of a task type, a task priority, a task assignee, a task creation date, and a task due date. In addition, or in alternative, the graphic user interface 110 can display a task feed can include a task overview (e.g., name, assignee, due date, etc.) for one or more tasks. In this regard, the user task can be configured to promote the brand on the online marketplace and to streamline workflows of the brand. In examples, the server 120 can be configured to generate a report that includes a number of tasks to be performed within a specified time period (e.g., hours, days, weeks, months, etc.). User tasks can be manually or automatically (as discussed further below) generated via the task manager dashboard.

In examples, the graphic user interface 110 can include a plurality of dashboards that includes a task management dashboard 150 as discussed above and at least one support dashboard 160. In examples, each support dashboard in the at least one support dashboard 160 can be configured to be in communication with the task management dashboard 150 such that a task can be generated by the at least one user via the support dashboard.

The at least one support dashboard 160 can display, based on the bulk input of seller information, at least one of detailed seller information and corresponding metrics. In examples, the at least one support dashboard 160 can include at least one of an accounting support dashboard in which accounting information is shown and an inventory support dashboard in which inventory information is shown. Detailed seller information can include any information that promotes data-driven sales processes and lead generation, for example, well-established sales, marketing, and economic data points and trends as well as “next generation” sales, marketing, and economic data points and trends. For example, detailed seller information can include break-even analyses, sales price per unit, variable cost per unit, conversion percentage, advertising costs, etc. In addition, the detailed seller information can be shown in comparison with general seller information, e.g., for a particular product or line of products or similar products sold on the online marketplace. Detailed inventory information can include lost and damaged inventory metrics such as the quantity of lost and damaged inventory, replacement costs, and the like.

In examples, the server 120 can be configured to operate in an autopilot mode that intelligently manages the brand. A user can select automation settings, for example, via any of the dashboards discussed elsewhere herein (e.g., the Glide dashboard 170 shown in FIG. 1E). When in autopilot mode, the system can generate and/or perform the user tasks. For example, when in autopilot mode, at least one of the tasks can be automatically generated by the server 120. In this regard, various aspects of the user task, can be determined and generated by the server 120, including one or more of a task priority, a task assignee, a task creation date, and a task due date. In examples, the server 120 can be configured to intelligently (e.g., using artificial intelligence principles such as machine learning and big data) perform a number of processes. For example, the server 120 can be configured to intelligently create at least one task for the user based, for example, on the task information and the at least one task criterion. The server 120 can be configured to intelligently suggest at least one task for the user based on the task information, the at least one task criterion.

In examples, the system can include providing an alert to the user when the at least one task management criterion is met. Providing an alert can occur whether the system is operating in autopilot mode or not. In examples, the alert can be in a form of a message 180 (e.g., an email, push notification, or the like) sent to the user. In examples, the at least one task management criterion can include a new item needed to be shipped, a new message 180 in need of a response, or a range or threshold for a number of sales, conversion, traffic, or profitability, for example.

In examples, the server 120 can be configured to acquire the bulk input of seller information through a handshake of access keys between the server 120 and the online marketplace. In examples, the handshake of access keys can include satisfying a two-factor authentication criteria for the online marketplace. The handshake can be facilitated via a user setup process. Such a process can include logging into a seller account and adjusting permissions to allow access to the seller account via the serer (e.g., using server 120-provided credentials). It is contemplated that the handshake can be performed automatically by the server 120 in some instances.

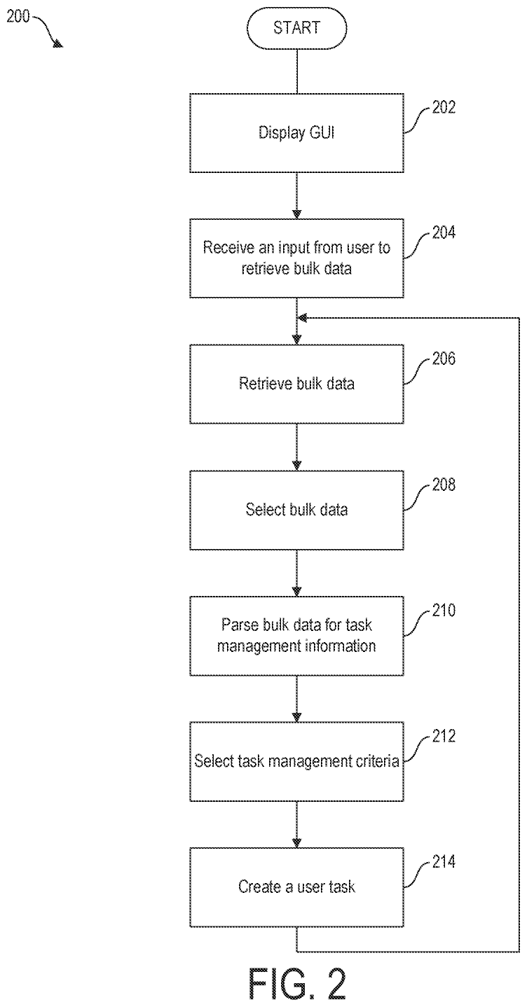

FIG. 2 shows a flowchart of a method 200 of managing tasks for a brand on an online marketplace. At step 202, the method 200 can include displaying, via a display device, a graphic user interface. At step 204, the method 200 can include receiving, via a server in communication with the display device, an input from at least one user to retrieve a bulk input of seller information, including task management information, from the online marketplace. At step 206, the method 200 can include retrieving, via the server, the bulk input of seller information from the online marketplace. At step 208, the method 200 can include selecting the bulk input of seller information. At step 210, the method 200 can include parsing the bulk input for the task management information for creating a user task for a user of the at least one user. At step 212, the method 200 can include selecting at least one task management criterion for creating the user task. At step 214, the method 200 can include creating the user task based on the task management information and the at least one task management criterion. The user task can be assignable to the user and be displayed on the graphic user interface after creation of the user task. The user task can be further configured to promote the brand on the online marketplace and to streamline workflows of the brand.

In examples, the method 200 can include several steps being performed using the server or processor (e.g., via the non-transitory computer readable medium). For example, the server can be used to perform selecting the bulk input of seller information. The server can be used to perform parsing the bulk input for the task management information for creating the user task. The server can be used to perform selecting the at least one task management criterion for creating the user task. The server can be used to perform creating the user task based on the task management information and the at least one task management criterion. As shown, for example, when in autopilot mode, the method 200 can include a feedback loop that causes the method 200 to loop back to any of the previous steps 204-212, for example, without user intervention.

As noted above, in examples, creating tasks for the user based on the task information and the at least one task criterion is intelligently performed via the server. The method 200 can further include suggesting, intelligently via the server, at least one task for the user based on the task information and the at least one task criterion. In examples, the method 200 can include operating in an autopilot mode whereby at least one task is automatically generated by the server. In examples, the autopilot mode can include providing alerts to the user when the at least one task management criterion is met. In examples, the at least one task management criterion can include a new item needed to be shipped, a new message in need of a response, or a range or threshold for a number of sales, conversion, traffic, or profitability.

It is noted that the present disclosure also includes non-transitory computer readable mediums having stored thereon software instructions that, when executed by a processor, cause the processor to generate. In this regard, “non-transitory computer-readable medium” includes types of storage devices that do not necessarily store information permanently, including for example, random access memory (RAM). So configured, the processor can perform each of the functions of the server and/or display device discussed above, for example. As well, the processor can perform each of the steps of the methods disclosed elsewhere herein, including the method 200.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an example, B alone can be present in an example, C alone can be present in an example, or that any combination of the elements A, B or C can be present in a single example; for example, A and B, A and C, B and C, or A and B and C.

In the detailed description herein, references to “one example,” “an example,” “an instance,” etc., indicate that the example described can include a particular feature, structure, or characteristic, but every example can not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art with the benefit of the present disclosure to affect such feature, structure, or characteristic in connection with other examples whether or not explicitly described. After reading the description, it will be apparent to one skilled in the relevant art(s) how to implement the disclosure in alternative examples.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus

While the present disclosure has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

Various modifications and additions can be made to the exemplary examples discussed without departing from the scope of the present invention. For example, while the examples described above refer to particular features, the scope of this invention also includes examples having different combinations of features and examples that do not include all of the above described features.

1. A task management system for a brand on an online marketplace, the system comprising:
a graphic user interface running on a display device;
a server in communication with the display device, the server configured to perform a task management process comprising:
obtaining task management information using a bulk input of seller information from the online marketplace, the seller information being derived from one or more discrete locations requiring user authentication on the online marketplace and accessed using an authentication code that is required to access each of the locations in the one or more discrete locations;
modifying the task management information using at least one task management criterion, wherein the at least one task management criterion is designed to facilitate creating a user task to thereby promote the brand on the online marketplace and to streamline workflows of the brand;
creating the user task based on the modified task management information, wherein the user task is assignable to at least one user and is displayed on the graphic user interface after creation of the user task such that the user task supports promoting the brand on the online marketplace and streamlining workflows of the brand.

2. The system of claim 1, wherein the graphic user interface comprises a plurality of dashboards that includes a task management dashboard and at least one support dashboard that displays, based on the bulk input of seller information, at least one of detailed seller information and corresponding metrics.

3. The system of claim 2, wherein each support dashboard in the at least one support dashboard is configured to be in communication with the task management dashboard such that a task can be created by the at least one user via the support dashboard.

4. The system of claim 2, wherein the at least one support dashboard includes at least one of an accounting support dashboard in which accounting information is shown and an inventory support dashboard in which inventory information is shown.

5. The system of claim 1, wherein the server is further configured to generate a report that includes a number of tasks to be performed within a specified time period.

6. The system of claim 1, wherein the server is further configured to intelligently perform at least one of these processes:
create at least one task for the user based on the task information and the at least one task criterion; and
suggest at least one task for the user based on the task information, the at least one task criterion.

7. The system of claim 1, wherein the server is further configured to automatically create the user task by way of the server periodically performing the task management process.

8. The system of claim 7, wherein the task management process further includes providing an alert to the user when the at least one task management criterion is met.

9. The system of claim 8, wherein the at least one task management criterion includes a new item needed to be shipped, a new message in need of a response, or a range or threshold for a number of sales, conversion, traffic, or profitability.

10. The system of claim 8, wherein the alert is in a form of an email sent to the user.

11. The system of claim 1, wherein the server is configured to acquire the bulk input of seller information through a handshake of access keys between the server and the online marketplace.

12. The system of claim 11, wherein the handshake of access keys includes satisfying a two-factor authentication criteria for the online marketplace.

13. The system of claim 11, wherein the graphic user interface displays at least two of a task feed comprising a task overview for a number of tasks, a task priority, a task assignee, a task creation date, and a task due date.

14. The system of claim 1, wherein the graphic user interface comprises a plurality of dashboards that includes a task management dashboard and at least two departmental dashboards that include glide, revenue, insights, and tenacity; and wherein the task management dashboard is configured to categorize the user tasks into groupings that correspond to each of the departmental dashboards in the at least two departmental dashboards.

15. A method of managing tasks for a brand on an online marketplace, comprising:
displaying, via a display device, a graphic user interface;
obtaining, via the server, task management information using a bulk input of seller information from the online marketplace, the seller information being derived from one or more discrete locations requiring user authentication on the online marketplace and accessed using an authentication code;
modifying the task management information using at least one task management criterion, wherein the at least one task management criterion is designed to facilitate creating a user task to thereby promote the brand on the online marketplace and to streamline workflows of the brand;
creating the user task based on the modified task management information, wherein the user task is assignable to at least one user and is displayed on the graphic user interface after creation of the user task such that the user task supports promoting the brand on the online marketplace and streamlining workflows of the brand.

16. The method of claim 15, wherein these steps are performed via the server:
modifying the task management information using at least one task management criterion; and
creating the user task based on the modified task management information.

17. The method of claim 15, wherein creating the user task based on the modified task management information is intelligently performed via the server, and wherein the method further comprises suggesting, intelligently via the server, at least one task for the user based on the task information and the at least one task criterion.

18. The method of claim 15, wherein the method further comprises operating automatically create the user task by way of the server periodically performing the task management process.

19. The method of claim 18, wherein the method further includes providing an alert to the user when the at least one task management criterion is met.

20. The method of claim 19, wherein the at least one task management criterion includes a new item needed to be shipped, a new message in need of a response, or a range or threshold for a number of sales, conversion, traffic, or profitability.
